(19) United States
(12) Patent Application Publication
(10) Pub. No.: US 2008/0034967 A1
(43) Pub. Date: Feb. 14, 2008

(54) Filter Device for Administration of Stored Gases

(76) Inventor: Jeffrey H. Ping, Braselton, GA (US)

Correspondence Address: SUTHERLAND ASBILL & BRENNAN LLP, 999 PEACHTREE STREET, N.E., ATLANTA, GA, 30309, US

(21) Appl. No.: 11/570,819

(22) PCT Filed: Jun. 17, 2005
(86) PCT No.: PCT/US05/21442

§ 371 Date: Oct. 12, 2007

Related U.S. Application Data
(60) Provisional application No. 60/581,221, filed on Jun. 18, 2004.

(51) Int. Cl. B03C 3/34; B01D 39/00

(52) U.S. Cl. 95/63; 55/522; 95/286; 96/55

(57) ABSTRACT

This invention relates to the field of connectors used to connect gas sources to apparatus for the administration or other use of gas or mixtures of gases, and more specifically to filters used to remove biological contaminants that might be colonized with the pressurized containers used in gas administration for respiratory support of a user or patient or other applications where biological contamination is not desired.

### TECHNICAL FIELD OF THE INVENTION

The present invention relates generally to the field of stored compressed gases for medically therapeutic or other respiratory support applications or environmentally controlled systems in which biological contamination of the contained gas would pose a threat to safety of individuals inhaling the contaminated gas or the integrity of the process within an environmentally controlled system. More specifically, the present invention relates to biologic filter devices and methods for their use in conjunction with stored compressed gases to prevent the transmission of microbes as the gas is dispensed for use.

### BACKGROUND OF THE INVENTION

In industrial, healthcare, aerospace, and recreational underwater settings, a gas or mixture of gases is often contained within pressurized cylinders, tanks, or other containers, from which a controlled release of the gas is effected for a desired purpose. In many such applications, compressed air, pure oxygen, or a mixture of oxygen and other gases is often contained within pressurized cylinders, tanks, or other vessels and dispensed for use in breathing by persons in low oxygen environments, or by persons with impaired respiratory function. In certain industrial and research settings, it is desirable to provide a controlled atmosphere with a specific ambient gas or gas mixture contained, and common gas sources must be connected to an environmental chamber to deliver the desired atmospheric content.

Colonization of pressurized gas cylinders, tanks, and other containers by pathogenic microbes may result in transmission of disease to individuals relying upon delivery of gas from those containers for respiratory support, potentially causing pneumonitis, lung abscesses, or other respiratory infections.

Colonization of pressurized gas cylinders, tanks, and other containers by microbes may result in the undesirable transmission of those microbes to controlled environmental systems connected to those gas sources, with potentially adverse environmental sequelae with respect to the processes contained within those systems.

Existing technology for pressurized gas cylinders, tanks, and other containers does not provide for filtration of biologic materials to prevent the transmission of microbes through a gas delivery system.

A need exists, therefore, to provide a biological filter capable of removing potential pathogens, other microbes, and endotoxins from compressed gas sources during their use in industrial, research, medical, aerospace, or underwater applications requiring use of such gas sources.

### SUMMARY OF THE INVENTION

It is an object according to the present invention to provide gas delivery systems with biologic filtration devices to prevent inadvertent transmission of microbes and endotoxins during delivery of contained gas.

It is a further object according to the present invention to provide gas delivery systems with inline filtration systems that may be quickly and easily replaced during use of a gas delivery apparatus with compressed gas sources.

These and other features, aspects, and other advantages according to the present invention will become more apparent and more readily understood with regard to the following specification, drawings, description, appended claims, and any examples of the present preferred embodiments of the invention which are disclosed herein.

### BRIEF DESCRIPTION OF THE DRAWINGS

FIG. 1 provides a drawing of an exemplary inline biologic filter according to the present invention, in which a compressed gas passes directly through a barrier capable of biologic filtration in the process of delivery for end use of the gas.

FIG. 2 provides a drawing of another exemplary inline biologic filter according to the present invention, in which a compressed gas passes directly through a filtration housing containing a series of baffles with surfaces capable of biologic filtration in the process of delivery for end use of the gas.

FIG. 3 provides a drawing of a still another exemplary inline biologic filter according to the present invention, in which a compressed gas passes directly through a filtration housing filled with filtering material capable of biologic filtration in the process of delivery for end use of the gas.

FIG. 4 shows a classic fractional collection efficiency versus particle diameter for a mechanical filter.

FIG. 5 shows exemplary test results for a MERV 9 filter and the corresponding filter collection efficiency increase due to loading.

FIG. 6 provides a drawing of an another exemplary inline biologic filter according to the present invention, in which a compressed gas from a gas cylinder passes directly through a barrier capable of biologic filtration in the process of delivery for end use of the gas by a patient.

### DETAILED DESCRIPTION OF THE INVENTION

The present invention may be understood more readily by reference to the following detailed description of the preferred embodiments of the invention and the Examples included herein. However, before the preferred embodiments of the devices and methods according to the present invention are disclosed and described, it is to be understood that this invention is not limited to the exemplary embodiments described within this disclosure, and the numerous modifications and variations therein that will be apparent to those skilled in the art remain within the scope of the invention disclosed herein. It is also to be understood that the terminology used herein is for the purpose of describing specific embodiments only and is not intended to be limiting.

Unless otherwise noted, the terms used herein are to be understood according to conventional usage by those of ordinary skill in the relevant art. In addition to the definitions of terms provided below, it is to be understood that as used in the specification and in the claims, “a” or “an” can mean one or more, depending upon the context in which it is used.

As used herein in the specification, “a” or “an” may mean one or more. As used herein in the claim(s), when used in conjunction with the word “comprising”, the words “a” or “an” may mean one or more than one. As used herein “another” may mean at least a second or more.

The term “container” as used herein is defines as any gas cylinder, tank, or other vessel used to confine and contain a gas for controlled release and use thereof.

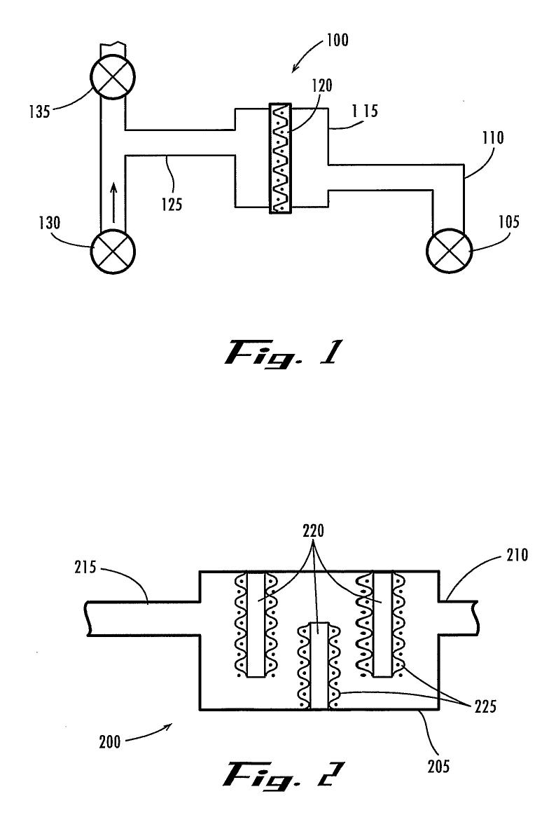

Referring now to an exemplary biologic filtration system for a compressed gas source as shown in FIG. 1, a filter system 100 comprises a filter housing 115 which is in flow continuity with a gas source 105 through a connector 110. Within the filter housing 115 a biologic filter 120 is positioned such that all gas flowing through the filter housing 115 must pass through the biologic filter 120. Once passing though the biologic filter 120, the gas leaves the filter housing 115 through an efferent connector 125. The efferent connector may be provided with one or more valves, including bleed-off valves 130 to allow bleed-off venting of excess gas and delivery valves 135 that regulate gas delivery for its end use.

An alternate embodiment according to the present invention is shown in FIG. 2, where a filter system 200 comprises a filter housing 205 which is in flow continuity with a gas source [not shown] through a connector 210. Within the filter housing 205 biologic filter material 225 is positioned on a series of filter baffles 220 such that all gas flowing through the filter housing 205 must pass across the biologic filter material 225. Once passing across the biologic filter material 225, the gas leaves the filter housing 205 through an efferent connector 215.

Still another alternate embodiment according to the present invention is shown in FIG. 3, where a filter system 300 comprises a filter housing 305 with a housing lid 320 which may be fixed or removable in various applications. The filter housing 305 may contain one or more fenestrated baffles 315 within. Gas from a gas source [not shown] enters the filter housing 305 through an inlet 310 and passes through the filter housing 305 which is filled with biological filter material 325 to exit the filter through an outlet 330.

Filter materials for biologic filtration systems according to the present invention may rely upon one of four basic filter collection mechanisms: impaction, interception, diffusion, and electrostatic attraction.

Impaction occurs when a particle traveling in a gas or gas mixture stream passes around a fiber in a mechanical filter system, deviates from the gas stream due to particle inertia and collides with a filter system fiber.

Interception occurs when a large particle, because of its size, collides with a fiber in a mechanical filter that a gas stream is passing through.

Diffusion occurs when the random (Brownian) motion of a particle traveling in a gas stream causes that particle to contact a fiber in a mechanical filter.

Electrostatic attraction occurs when the motion of a particle traveling in a gas stream causes that particles to contact fibers in a filter, and once such contact is made, smaller particles are retained on the fibers by a weak electrostatic force. Electrostatic attraction plays a very minor role in mechanical filtration. However, electrostatic filters contain electrostatically enhanced fibers, which actually attract the particles to the fibers, in addition to retaining them. Electrostatic filters rely on charged fibers to dramatically increase collection efficiency for a given pressure drop across the filter.

Particulate air filters are classified as either mechanical filters or electrostatic filters (electrostatically enhanced filters). Although there are many important performance differences between the two types of filters, both are fibrous media and used to remove particles, including biological materials, from a flowing stream of gas. A fibrous filter is an assembly of fibers that may be randomly or non-randomly laid perpendicular or tangentially to the gas flow. The fibers may range in size from less than 1 μm to greater than 50 μm in diameter. Filter packing density may range from 1% to 30%. Fibers are made from cotton, fiberglass, polyester, polypropylene, porous silver, other porous metals, alumina, other porous ceramics, or other materials capable of allowing the through-flow of gas while mechanically retaining particulate matter, including biologic matter originally present within the gas stream.

Filters capable of removing particles of 0.45 μm will trap most microbes. In various embodiments according to the present invention, 0.45 μm filters may be employed alone, or as prefilters with arrays of one or more 0.2 μm filters in succession to provide for the filtering of smaller particles. In the filtration of injectable products, use of arrays of 2 or more 0.2 μm filters are commonly used with 0.45 μm prefilters.

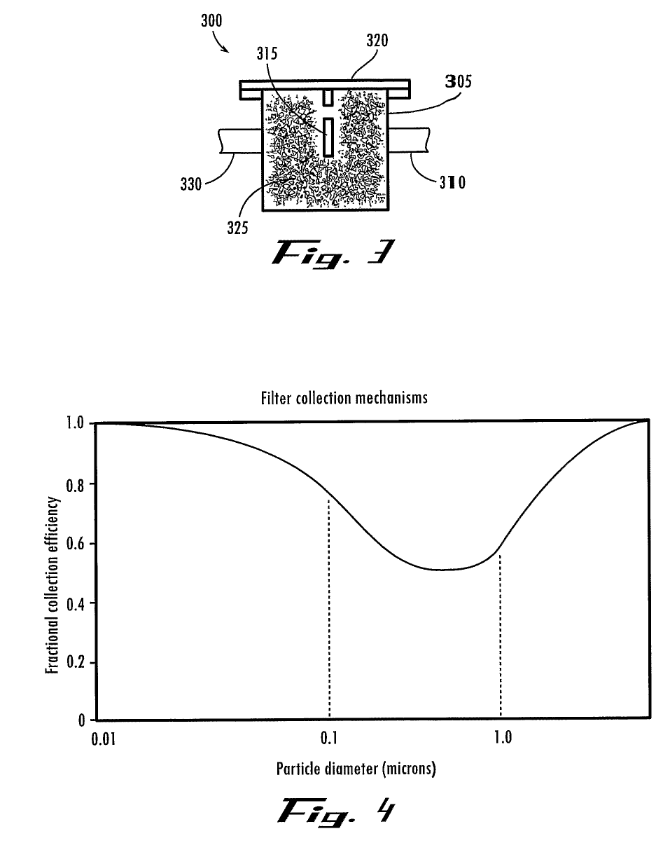

Impaction and interception are the dominant collection mechanisms in mechanical filters for particles greater than 0.2 μm, and diffusion is dominant for particles less than 0.2 μm. The combined effect of these three collection mechanisms results in the classic collection efficiency curve, shown in FIG. 4. The minimum filter efficiency shifts based upon the type of filter and flow velocity. (Note the dip for the most penetrating particle size and dominant collection mechanisms based upon particle size.)

As mechanical filters load with particles over time, their collection efficiency and pressure drop typically increase. Eventually, the increased pressure drop significantly inhibits gas flow, and the filters must be replaced. For this reason, pressure drop across mechanical filters is often monitored because it indicates when to replace filters.

Conversely, electrostatic filters, which are composed of polarized fibers, may lose their collection efficiency over time or when exposed to certain chemicals, aerosols, or high relative humidities. Pressure drop in an electrostatic filter generally increases at a slower rate than it does in a mechanical filter of similar efficiency. Thus, unlike the mechanical filter, pressure drop for the electrostatic filter is a poor indicator of the need to change filters.

Gas filters are commonly described and rated based upon their collection efficiency, pressure drop (or gas flow resistance), and particulate-holding capacity. Two filter test methods currently used in the United States include:
American Society of Heating, Refrigerating, and Air-Conditioning Engineers (ASHRAE) Standard 52.1-1992
ASHRAE Standard 52.2-1999

Standard 52.1-1992 measures arrestance, dust spot efficiency, and dust holding capacity. Arrestance means a filter's ability to capture a mass fraction of coarse test dust and is suited for describing low and medium-efficiency filters. Arrestance values may be high, even for low-efficiency filters, and does not adequately indicate the effectiveness of certain filters for CBR protection. Dust spot efficiency measures a filter's ability to remove large particles, those that tend to soil building interiors. Dust holding capacity is a measure of the total amount of dust a filter is able to hold during a dust loading test.

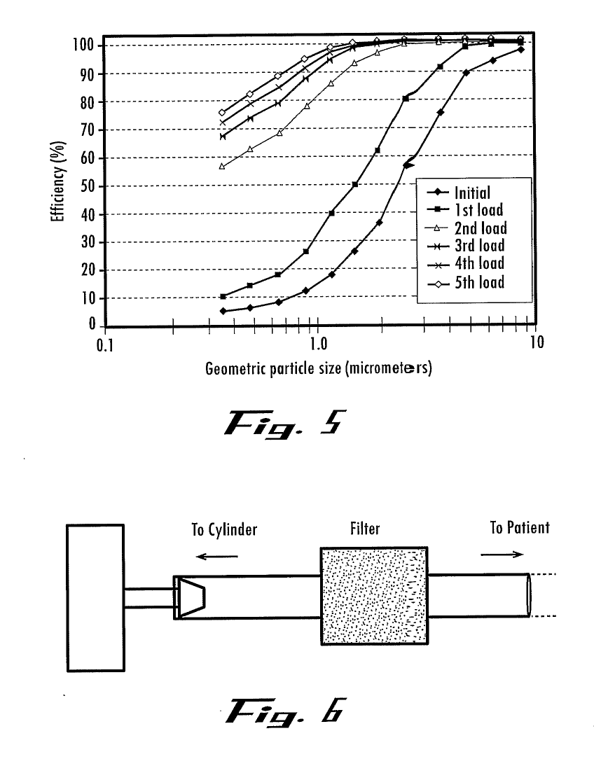

ASHRAE Standard 52.2-1999 measures particle size efficiency (PSE). This newer standard is a more descriptive test, which quantifies filtration efficiency in different particle size ranges for a clean and incrementally loaded filter to provide a composite efficiency value. It gives a better determination of a filter's effectiveness to capture solid particulate as opposed to liquid aerosols. The 1999 standard rates particle-size efficiency results as a MERV between 1 and 20. A higher MERV indicates a more efficient filter. In addition, Standard 52.2 provides a table (see Table 1) showing minimum PSE in three size ranges for each of the MERV numbers, 1 through 16. Thus, if you know the size of your contaminant, you can identify an appropriate filter that has the desired PSE for that particular particle size. FIG. 5 shows actual test results for a MERV 9 filter and the corresponding filter collection efficiency increase due to loading.

TABLE 1
Comparison of ASHRAE Standard 52.1 and 52.2

| | | | | ASHRAE 52.1 | | Particle | |
|---|---|---|---|---|---|---|---|
| ASHRAE 52.2 | | | | Test | | size | |
| | Particle size range | | | | Dust | range, | |
| MERV | 3 to 10 μm | 1 to 3 μm | .3 to 1 μm | Arrestance | spot | μm | Applications |
| 1 | <20% | — | — | <65% | <20% | >10 | residential |
| 2 | <20% | — | — | 65-70% | <20% | | light |
| 3 | <20% | — | — | 70-75% | <20% | | pollen, |
| 4 | <20% | — | — | >75% | <20% | | dust mites |
| 5 | 20-35% | — | — | 80-85% | <20% | 3.0-10 | industrial, |
| 6 | 35-50% | — | — | >90% | <20% | | dust, |
| 7 | 50-70% | — | — | >90% | 20-25% | | molds, |
| 8 | >70% | — | — | >95% | 25-30% | | spores |
| 9 | >85% | <50% | — | >95% | 40-45% | 1.0-3.0 | industrial |
| 10 | >85% | 50-65% | — | >95% | 50-55% | | Legionella, |
| 11 | >85% | 65-80% | — | >98% | 60-65% | | dust |
| 12 | >90% | >80% | — | >98% | 70-75% | | |
| 13 | >90% | >90% | <75% | >98% | 80-90% | 0.3-1.0 | hospitals, |
| 14 | >90% | >90% | 75-85% | >98% | 90-95% | | smoke |
| 15 | >90% | >90% | 85-95% | >98% | ~95% | | removal, |
| 16 | >95% | >95% | >95% | >98% | >95% | | bacteria |
| 17 | — | — | ≧99.97% | — | — | <0.3 | clean rooms, |
| 18 | — | — | ≧99.99% | — | — | | surgery, |
| 19 | — | — | ≧99.999% | — | — | | chem-bio, |
| 20 | — | — | ≧99.9999% | — | — | | viruses |

Some biologic filter systems according to the present invention may be provided with sorbent filters. Such sorbent filters use one of two mechanisms for capturing and controlling gas-phase contaminants—physical adsorption and chemisorption. Both capture mechanisms remove specific types of gas-phase contaminants from a gas or gas mixture. Unlike particulate filters, sorbents cover a wide range of highly porous materials varying from simple clays and carbons to complexly engineered polymers. Many sorbents—not including those that are chemically active—can be regenerated by application of heat or other processes.

High Energy Particulate Air (HEPA) filters may also be used singly or in combination with other biologic filters in various embodiments according to the present invention. As shown in Table 2, chemical and biological aerosol dispersions (particulates) are frequently in the 1- to 10-μm range, and HEPA filters provide efficiencies greater than 99.9999% in that particle size range, assuming there is no leakage around the filter and no damage to the fragile pleated media. This high level of filtration efficiency provides protection against most aerosol threats. Biological agents and radioactive particulates are efficiently removed by HEPA filters.

Sorbents have different affinities, removal efficiencies, and saturation points for different chemical agents, which you should consider when selecting a sorbent. The U.S. Environmental Protection Agency [EPA 1999] states that a well-designed adsorption system should have removal efficiencies ranging from 95% to 98% for industrial contaminant concentrations, in the range of 500 to 2,000 ppm; higher collection efficiencies are needed for high toxicity CBR agents.

Sorbent physicochemical properties—such as pore size and shape, surface area, pore volume, and chemical inertness—all influence the ability of a sorbent to collect gases and vapors. Sorbent manufacturers have published information on the proper use of gas-phase sorbents, based upon contaminants and conditions. Gas contaminant concentration, molecular weight, molecule size, and temperature are all important. The activated carbon, zeolites, alumina, and polymer sorbents selected as a filter material should have pore sizes larger than the gas molecules being adsorbed. This point is particularly important for zeolites because of their uniform pore sizes. With certain adsorbents, compounds having higher molecular weights are often more strongly adsorbed than those with lower molecular weights. Copper-silverzinc-molybdenum-triethylenediamine (ASZM-TEDA) carbon is the current military sorbent recommended for collecting classical chemical warfare agents.

Sorbents are rated in terms of their adsorption capacity (i.e., the amount of the chemical that can be captured) for many chemicals. This capacity rises as concentration increases and temperature decreases. The rate of adsorption (i.e., the efficiency) falls as the amount of contaminant captured grows. Information about adsorption capacity—available from manufacturers—will the service life of a sorbent bed to be predicted. Sorbent beds are sized on the basis of challenge agent and concentration, gas velocity and temperature, and the maximum allowable downstream concentration.

Gases are removed in the sorbent bed's mass transfer zone. As the sorbent bed removes gases and vapors, the leading edge of this zone is saturated with the contaminant, while the trailing edge is clean, as dictated by the adsorption capacity, bed depth, exposure history, and filtration dynamics. Significant quantities of an biologic gas contaminant may pass through the sorbent bed if breakthrough occurs.

A phenomenon known as channeling may occur in sorbent beds and should be avoided. Channeling occurs when a greater flow of air passes through the portions of the bed that have lower resistance. It is caused by non-uniform packing, irregular particle sizes and shapes, wall effects, and gas pockets. If channeling occurs within a sorbent bed, it can adversely affect filter system performance.

FIG. 6 shows another exemplary schematic diagram of a biologic filter device for the administration of stored gases according to the present invention, in which a compressed gas from a gas cylinder passes directly through a barrier capable of biologic filtration in the process of delivery for end use of the gas by a patient.

Exemplary specifications for at least one biologic filter device for the administration of stored gases according to the present invention are shown below in Table 3. Such exemplary devices are designed for sterilizing applications, removing particles and microorganisms from gases and solvents. They are made with PTFE membrane and polypropylene components for broad application compatibility.

TABLE 3
Specifications

| | |
|---|---|
| Materials of Construction | |
| Filter | Hydrophobic PTFE |
| Supports | Polypropylene |
| O-ring | Silicone O-rings |
| Connections | Code M (2-118) O-rings |
| Filtration Area, m² (ft²) | 0.05 |
| Maximum Differential | |
| Pressure, bar (psid) | |
| Forward: | 5.5 (80) @ 25° C.; 1.7 (25) @ 80° C.; |
| | 0.35 (5) @ 135° C.; |
| Reverse: | 4.1 (60) |
| Bacterial Retention | Quantitative retention of 10⁷ CFU/cm² |
| | Brevundimonas diminuta (ATCC ® 19146) |
| | per ASTM F838-83 methodology |
| Bacterial Endotoxins | <0.5 EU/mL as determined by the LAL test |
| Toxicity | Component materials meet the requirements |
| | of the USP Class VI Biological Test for |
| | Plastics. The cartridges also meet the |
| | requirements of the USP General (Mouse) |
| | Safety Test. |
| Sterilization | 80 (40 forward/40 reverse) SIP cycles of |
| | 30 min @ 135° C. |
| Integrity Test | |
| Bubble | ≧1100 mbar (16 psig) with 70//30% IPA/water |
| Point | |

Additional exemplary applications and qualities for biologic filter devices for the administration of stored gases according to the present invention include sterile tank venting, fermentation air applications, bioreactor inlet and outlet filtration, autoclaves, and sterile process gases. The sterilizing grade rating is based on ASTM liquid bacterial retention challenge. In gases this filter will remove contamination down to 0.01 μm. The biologic filter will also remove particles and microorganisms from gases and liquids for low flow rates. Cartridges will also sterilize alcohol streams. Compatibility is assured for a wide range of solvents.

Finally, while there have been shown and described and pointed out fundamental novel features of the present invention as applied to preferred embodiments thereof, it will be understood that various omissions and substitutions and changes in the materials, form, and details of the devices and processes illustrated, and in their operation, and in the method illustrated and described, may be made by those skilled in the art without departing from the spirit of the invention as broadly disclosed herein. All of the above-discussed patents and publications are hereby expressly incorporated by reference as if they were written directly herein.

We claim:

1. A biologic filter for inline use with compressed gas containers comprising a housing with at least one inlet port and at least one outlet port, said housing further containing a semipermeable filtration material of sufficient size and qualities to allow a gas stream to flow through said filter unimpeded, but to retain any biologic particulate matter contained within said gas stream, when said particulate matter is between 0.01μ and 10.0μ.

2. The biologic filter of claim 1, wherein said filtration material is fully interposed within said housing between said inlet port and said outlet port.

3. The biologic filter of claim 1, wherein said housing further contains a series of baffles with surfaces, and wherein said filter material is contained within said surfaces.

4. The biologic filter of claim 1, wherein said filtration material is a semipermeable membrane.

5. The biologic filter of claim 1, wherein said filtration material is fibrous.

6. The biologic filter of claim 1, wherein at least some of said filtration material is electrostatically charged to attract and retain certain of said particulate matter contained within said gas stream.

7. The biologic filter of claim 1, wherein said filtration material acts by impaction to retain any biologic particulate matter contained within said gas stream, when said particulate matter is between 0.01μ and 10.0μ.

8. The biologic filter of claim 1, wherein said filtration material acts by interception to retain any biologic particulate matter contained within said gas stream, when said particulate matter is between 0.01μ and 10.0μ.

9. The biologic filter of claim 1, wherein said filtration material acts by diffusion to retain any biologic particulate matter contained within said gas stream, when said particulate matter is between 0.01μ and 10.0μ.

10. The biologic filter of claim 1, wherein said filtration material acts by electrostatic attraction to retain any biologic particulate matter contained within said gas stream, when said particulate matter is between 0.01μ and 10.0μ.

11. The biologic filter of claim 1, wherein said filtration material comprises one or more types of fibrous, membranous, or electrostatic filters arranged in series within said housing.

12. The biologic filter of claim 1, wherein said filtration material acts by any combination of impaction, interception, diffusion, and/or electrostatic attraction to retain any biologic particulate matter contained within said gas stream, when said particulate matter is between 0.01μ and 10.0μ.

13. A method of filtering a stream of gas to retain any biologic particulate matter contained within said stream, comprising passing said gas stream through a biologic filter inline with compressed gas containers, said filter comprising a housing with at least one inlet port and at least one outlet port, said housing further containing a semipermeable filtration material of sufficient size and qualities to allow a gas stream to flow through said filter unimpeded, but to retain any particulate matter contained within said gas stream, when said particulate matter is between 0.01μ and 10.0μ.

14. The method of filtering a stream of gas in claim 13, wherein said filtration material is a semipermeable membrane.

15. The method of filtering a stream of gas in claim 13, wherein said filtration material is fibrous.

16. The method of filtering a stream of gas in claim 13, wherein at least some of said filtration material is electrostatically charged to attract and retain certain of said particulate matter contained within said gas stream.

17. The method of filtering a stream of gas in claim 13, wherein said filtration material acts by impaction to retain any biologic particulate matter contained within said gas stream, when said particulate matter is between 0.01μ and 10.0μ.

18. The method of filtering a stream of gas in claim 13, wherein said filtration material acts by interception to retain any biologic particulate matter contained within said gas stream, when said particulate matter is between 0.01μ and 10.0μ.

19. The method of filtering a stream of gas in claim 13, wherein said filtration material acts by diffusion to retain any biologic particulate matter contained within said gas stream, when said particulate matter is between 0.01μ and 10.0μ.

20. The method of filtering a stream of gas in claim 13, wherein said filtration material acts by electrostatic attraction to retain any biologic particulate matter contained within said gas stream, when said particulate matter is between 0.01μ and 10.0μ.

21. The method of filtering a stream of gas in claim 13, wherein said filtration material comprises one or more types of fibrous, membranous, or electrostatic filters arranged in series within said housing.

22. The method of filtering a stream of gas in claim 13, wherein said filtration material acts by any combination of impaction, interception, diffusion, and/or electrostatic attraction to retain any biologic particulate matter contained within said gas stream, when said particulate matter is between 0.01μ and 10.0μ.
